(19) United States
(12) Patent Application Publication
(10) Pub. No.: US 2009/0072834 A1
(43) Pub. Date: Mar. 19, 2009

(54) METHOD AND APPARATUS FOR CONDUCTING ELECTROMAGNETIC EXPLORATION

(76) Inventor: David Bruce Dickson, Midrand (ZA)

Correspondence Address: LAHIVE & COCKFIELD, LLP;FLOOR 30, SUITE 3000, ONE POST OFFICE SQUARE, BOSTON, MA, 02109, US

(21) Appl. No.: 12/090,564

(22) PCT Filed: Oct. 17, 2006
(86) PCT No.: PCT/IB06/02900

§ 371 Date: Oct. 14, 2008

(30) Foreign Application Priority Data
Oct. 17, 2005 (ZA) 2005/08394

(51) Int. Cl. G01V 3/10

(52) U.S. Cl. 324/357

(57) ABSTRACT

The invention is concerned with electromagnetic exploration of the earth's surface. In a method proposed by the invention, a primary coil is powered to generate a primary field and the primary field is applied to the earth and a receiver, used to detect a secondary field generated by the earth in response to the primary field, is moved over the surface of the earth. According to the invention, Helmholtz coils (14.1, 14.2) are arranged in a predetermined array and are powered in such a manner that they generate, in a volume accommodating the receiver, a magnetic field which serves at least partially to null the magnetic field of the earth. The invention also provides apparatus for carrying out the method.

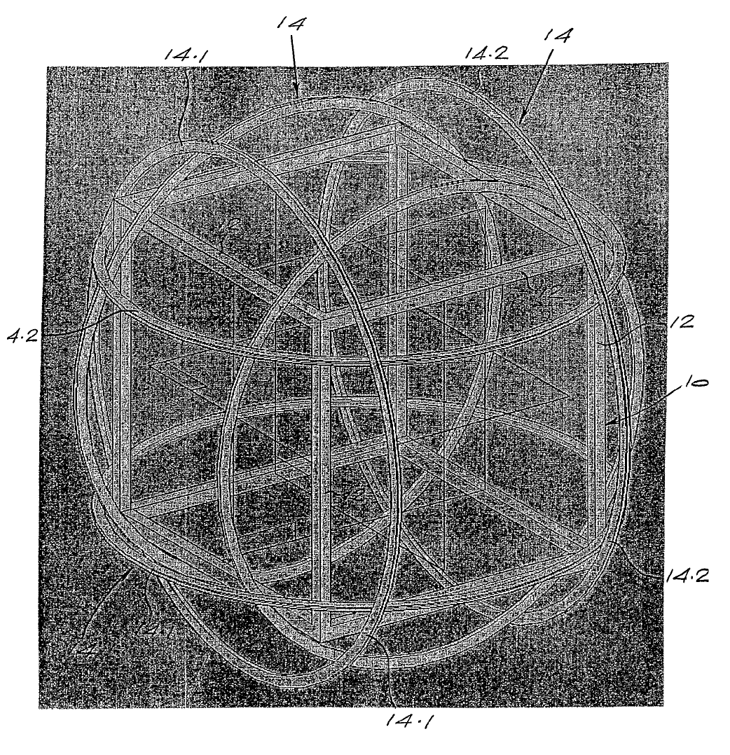

### BACKGROUND TO THE INVENTION

This invention relates to a method and apparatus for conducting electromagnetic exploration, i.e. geophysical survey.

It is known in electromagnetic exploration systems to make use of a high power transmitter which generates a primary, time-varying electromagnetic field by means of a transmitter loop. The primary field excites currents in the earth which in turn generate a secondary field. The secondary field detected by a receiver can be used in analysis of, for instance, the earth's composition.

The apparatus used in the system is moved over the earth's surface in order to carry out the required survey. However movement of the receiver through the natural magnetic field of the earth gives rise to signal noise.

The present invention seeks to provide an exploration method in which the signal noise attributable to movement of the receiver through the earth's magnetic field is at least reduced.

### SUMMARY OF THE INVENTION

According to one aspect of the invention there is provided a method of conducting electromagnetic exploration in which a primary coil is powered to generate a primary field, the primary field is applied to the earth and a receiver, used to detect a secondary field generated by the earth in response to the primary field, is moved over the surface of the earth, characterised in that the method includes the steps of arranging Helmholtz coils in a predetermined array and powering the coils such that they generate, in a volume accommodating the receiver, a magnetic field which serves at least partially to null the magnetic field of the earth.

Further according to the invention there is provided apparatus for conducting electromagnetic exploration in which a primary coil is powered to generate a primary field, the primary field is applied to the earth and a receiver, used to detect a secondary field generated by the earth in response to the primary field, is moved over the surface of the earth, the apparatus including Helmholtz coils arranged in a predetermined array, and means for powering the coils such that they generate, in a volume accommodating the receiver, a magnetic field which serves at least partially to null the magnetic field of the earth.

Other features of the method and apparatus are described below and set forth in the appended claims.

### BRIEF DESCRIPTION OF THE DRAWING

The invention will now be described in more detail, by way of example only, with reference to the accompanying drawing which diagrammatically illustrates an apparatus according to the invention.

### DESRIPTION OF THE ILLUSTRATED EMBODIMENT

The drawing shows a frame 10 composed of members 12 arranged along the edges of a cube. The frame supports three identical Helmholtz coil pairs 14 each composed of identical, spaced apart coils 14.1, 14.2. In effect the frame 10 and coil pairs 14 form a cage.

In operation, the receiver of an electromagnetic exploration apparatus is mounted centrally in the cage. Those skilled in the art will recognise that the exploration apparatus (in the interests of clarity of illustration, not shown in the drawing) includes a primary coil acting as a high power transmitter to generate a time-varying primary electromagnetic field, and a receiver. As the apparatus is moved over the surface of the earth, for instance on an aircraft or surface conveyance, the primary field is applied to the earth and the receiver picks up the secondary electromagnetic field generated by the earth in response to the primary field.

As explained above, a spurious noise signal is generated by movement of the receiver through the earth's natural magnetic field. According to the present invention, this spurious noise signal is at least reduced by arranging the Helmholtz coil pairs and powering them in such a way that a composite magnetic field at least approximately equal and opposite to the earth's magnetic field is generated inside the cage formed by the coils, i.e. in the vicinity of the receiver.

Three alternative systems for controlling the supply of power to the Helmholtz coil pairs are envisaged, as follows:
1. In an open loop control system, the currents in each of the Helmholtz coil pairs are set according firstly to prior knowledge of the earth's magnetic field in the particular area under exploration and secondly to real-time knowledge of the movement of the exploration apparatus over the surface of the earth. It is anticipated that this system could be successful in reducing noise by as much as 90%, translating into an improvement in the signal to noise ratio of the order of 20 dB.
2. In a semi-closed loop control system, the earth's field is sensed in real time by a vector magnetic field sensor located remotely from the receiver of the exploration apparatus. A current source then drives the appropriate Helmholtz coil pair(s) in response to the detected field signal. This control signal may be band limited to eliminate interaction between the primary field and the nulling arrangement consisting of the array of Helmholtz coil pairs. With appropriate account, in terms of feedback constants, taken of the possible influence which the nulling magnetic field may have on the sensor which senses the earth's magnetic field, it is envisaged that as much as 98% of the noise may be reduced, translating into an improvement of signal to noise ratio of 34 dB.
3. In a closed loop system, the vector magnetic field sensor mentioned above may be located within the nulling volume and possibly within the receiver apparatus itself. In this case, the presence of static or slowly varying magnetic fields, eg the earth's magnetic field, is detected and eliminated with a completely closed loop system. In this version it is envisaged that as much as 99.5% of the earth's field can be eliminated, translating into an improvement of signal to noise ratio exceeding 46 dB.

Although specific mention has been made of a Helmholtz coil array consisting of three coil pairs in mutually orthogonal relationship with one another, this particular geometry is not essential. It is envisaged that other arrays of Helmholtz coil pairs of appropriate design could also serve to create, in a nulling volume accommodating the receiver, a magnetic field which could effectively null the earth's field.

1. A method of conducting electromagnetic exploration in, which a primary coil is powered to generate a primary field, the primary field is applied to the earth and a receiver, used to detect a secondary field generated by the earth in response to the primary field, is moved over the surface of the earth, wherein the method comprises arranging a plurality of Helmholtz coils in a predetermined array and powering the plurality of Helmholtz coils such that they generate, in a volume accommodating the receiver, a magnetic field which serves at least partially to null the magnetic field of the earth.

2. A method according to claim 1 wherein pairs of Helmholtz coils are arranged in a mutually orthogonal relationship with one another around the volume accommodating the receiver.

3. A method according to claim 2 wherein three pairs of Helmholtz coils are arranged in a mutually orthogonal relationship with one another around the volume accommodating the receiver.

4. A method according to claim 3 wherein the three pairs of Helmholtz coils are supported in a mutually orthogonal relationship on a frame around the volume.

5. A method according to claim 4 wherein the three pairs of Helmholtz coils are arranged in a mutually orthogonal relationship around a cube-shaped frame.

6. A method according to claim 1 further comprising arranging the Helmholtz coils in pairs, supplying power to the coils in an open loop system, and setting the current in each pair of coils according to the magnetic field of the earth in a specific area in which exploration is being conducted and according to movement of the receiver over the surface of the earth.

7. A method according to claim 1 further comprising arranging the plurality of Helmholtz coils in pairs, supplying power to the coils in a semi-closed loop system, detecting the magnetic field of the earth by a vector magnetic field sensor located remotely from the receiver, and supplying current to the pairs of coils in dependence on a control signal generated by the magnetic field sensor.

8. A method according to claim 7 wherein the control signal is band limited to eliminate interaction between the primary field and a nulling field generated by the coil pairs.

9. A method according to claim 1 further comprising arranging the plurality of Helmholtz coils in pairs, supplying power to the coils in a closed loop system, detecting the magnetic field of the earth by a vector magnetic field sensor located in within the volume accommodating the receiver, and supplying current to the pairs of coils in dependence on a control signal generated by the magnetic field sensor.

10. An apparatus for conducting electromagnetic exploration in which a primary coil is powered to generate a primary field, the primary field is applied to the earth and a receiver, used to detect a secondary field generated by the earth in response to the primary field, is moved over the surface of the earth, the apparatus comprising a plurality of Helmholtz coils arranged in a predetermined array, and means for powering the coils such that the plurality of coils generate, in a volume accommodating the receiver, a magnetic field which serves at least partially to null the magnetic field of the earth.

11. An apparatus according to claim 10 comprising pairs of Helmholtz coils arranged in a mutually orthogonal relationship with one another around the volume accommodating the receiver.

12. An apparatus according to claim 11 comprising three pairs of Helmholtz coils arranged in a mutually orthogonal relationship with one another around the volume accommodating the receiver.

13. An apparatus according to claim 12 comprising a frame around the volume, the three pairs of Helmholtz coils being supported in a mutually orthogonal relationship on the frame.

14. An apparatus according to claim 13 wherein the frame comprises members arranged at the edges of a cube.

15. An apparatus according to claim 10 wherein the plurality of Helmholtz coils are arranged in pairs, the apparatus further comprising means for supplying power to the coils, in an open loop system, according to the earth's magnetic field in a specific area in which exploration is being conducted and according to of the movement of the receiver over the surface of the earth.

16. An apparatus according to claim 10 wherein the plurality of Helmholtz coils are arranged in pairs, the apparatus further comprising a vector magnetic field sensor located remotely from the receiver to detect the magnetic field of the earth, and means for supplying current to the coil pairs, in a semi-closed loop system, in dependence on a control signal generated by the vector magnetic field sensor.

17. An apparatus according to claim 10 wherein the plurality of Helmholtz coils are arranged in pairs, the apparatus further comprising a vector magnetic field sensor located within the volume accommodating the receiver to detect the magnetic field of the earth in real time, and means for supplying power to the coils, in a closed loop system, in dependence on a control signal generated by the magnetic field sensor.
